(19) United States
(12) Patent Application Publication
(10) Pub. No.: US 2004/0054469 A1
(43) Pub. Date: Mar. 18, 2004

(54) Vehicle navigation system

(76) Inventor: Joachim Rentel, Giesen (DE)

Correspondence Address: Striker Striker & Stenby, 103 East Neck Road, Huntington, NY, 11743, US

(21) Appl. No.: 10/451,871

(22) PCT Filed: Dec. 20, 2001
(86) PCT No.: PCT/DE01/04828

(30) Foreign Application Priority Data
Dec. 28, 2000 (DE) 100 65 523.8

(51) Int. Cl. G01C 21/30

(52) U.S. Cl. 701/211; 340/995.16

(57) ABSTRACT

A vehicle navigation system includes a navigation component (2), which includes a memory (4, 5, ?) for geographic data and a processor (8) for generating navigation information from the geographic data, and the system also includes a mobile phone (1) as a user interface for inputting requests to the navigation component and for displaying navigation information furnished by the navigation component (2).

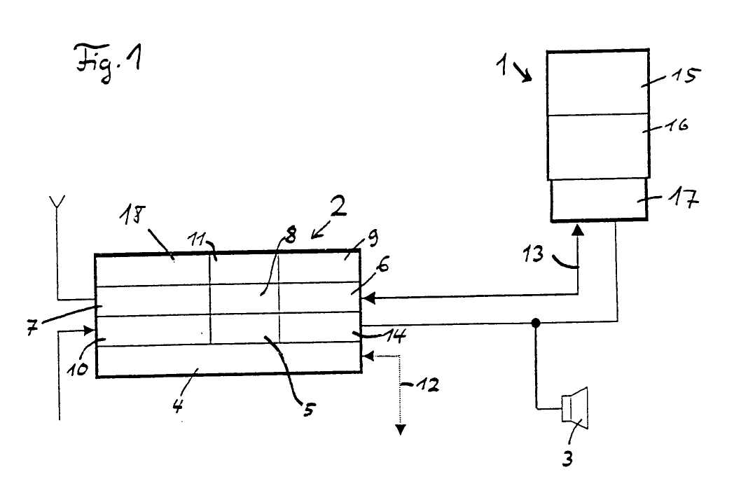

### PRIOR ART

The present invention relates to a vehicle navigation system having a navigation component and a user interface that is separate from the navigation component.

The purpose of such navigation systems is, from geographic data present in a memory of the system and on the basis of a search request from a user input via the interface, for instance the request for a destination, to ascertain a possible route to the destination and to output the thus-ascertained information to the user.

A great majority of such vehicle navigation systems are not part of the standard equipment of vehicles but are essentially retrofitted in existing vehicles. For optimal ease of use of such a navigation system, it would intrinsically be advantageous if a complete alphanumeric keyboard could be made available for inputting a search request, and a large-size screen could be made available for displaying the results. For that purpose, the space that is available on a dashboard or center console of a vehicle is greatly inadequate.

To reduce the space required by such a system, navigation systems which comprise a navigation component that includes a memory for geographic data and a processor for generating navigation information from the geographic data have been developed, in which the function of the user interface is performed by a car radio especially equipped for the purpose. In other words, besides its normal functions, the car radio makes the entire control panel of the navigation component available. Such a car radio is produced for instance by Blaupunkt. Communication between the car radio and the navigation component is accomplished via a CAN bus, with an especially developed protocol. It is not expected that this protocol will be adopted in future by all car radio manufacturers.

Conventional navigation systems use a fixed set of geographic data, which is usually stored on optical data carriers such as CD-ROM. It is true that such systems can, with knowledge of the starting point and destination point of a trip, suggest a route to a user and, with the support of information about the current location of the vehicle, received over the course of the trip, can supply the driver with supporting information that makes it easier for him to follow the proposed route; however, they are not capable of taking into account such temporary changes in the traffic situation as construction sites, traffic jams, and so forth, which can certainly be very important to the driver in deciding for or against a proposed route. To avoid traffic jams, the driver who has a navigation system in his vehicle must also listen to traffic reports on the radio and evaluate TMC traffic reports, or must procure such information from commercial telematics services, which broadcast the information over the GSM mobile radio network.

More-sophisticated navigation systems have a so-called telematics box as an additional functional component; it receives the current traffic information from the telematics service provider over a specialized mobile phone that is not conventionally available on the market, and also communicates with the navigation component and the car radio via the CAN bus. The costs for such a system, given the many components and until now the still low number produced, are high.

There is accordingly a considerable need for a vehicle navigation system which can easily be retrofitted in a vehicle, which is produced in large numbers, uses inexpensive components, and nevertheless offers the same or even better ease of use than conventional systems.

### ADVANTAGES OF THE INVENTION

The invention creates a vehicle navigation system having the characteristics of claim 1. Refinements are the subject of the dependent claims.

The fundamental concept of the invention is to replace the car radio, as a user interface, with a commonly used mobile phone. Mobile phones, for instance on the GSM standard, necessarily have a keypad for inputting numbers to be called; this keypad is also suitable for inputting letters and as a rule is also already used for that purpose, for instance for editing entries in the phonebook. With the aid of such a keypad, a search request to the navigation component can be formulated more simply and quickly than if in a car radio, for instance, an alphabet were shown on its display field and a user were forced to select each letter individually by moving a cursor. The display field that is necessarily also present in mobile phones can be used to display alphanumeric information furnished by the navigation component. The display of graphic information is also possible. Moreover, it can then be expected that with the introduction of the WAP standard, mobile phones with larger and more convenient screens than current models have will be available economically and in large numbers in the near future.

For communication between the mobile phone and the navigation component, a serial interface can be used, as defined for instance by GSM standard 07.05 V5.5.0.

To output audio information furnished by the navigation component, a hands-free system connected to the mobile phone can be used. Since most motor vehicles in which a mobile phone is used already have such a hands-free system, the capability of outputting audio information involves no additional cost whatever to the buyer of a vehicle navigation system according to the invention.

Over the interface between the navigation component and the mobile phone, however, not only can requests be transmitted from the mobile phone to the navigation component and in response to them can information furnished by the navigation component be transmitted back to the mobile phone, but also the memory and processing capacity of the navigation component can furthermore be used to expand the performance characteristics of the mobile phone. In particular, in addition to the geographic data, the navigation component can include a memory for terminal addresses that are contactable with the aid of the mobile phone, and the mobile phone can be set up for accessing this memory for contacting a distant terminal in the same way as it accesses an internal list of telephone numbers.

The terminal addresses that can be contacted with the aid of the mobile phone include not only numbers of other telephones; e-mail addresses for automatic insertion into SMS messages can also be included in this memory.

Another advantage from incorporating the mobile phone into the vehicle navigation system is that with the aid of the mobile phone, it is simple to send information about the current position of the vehicle that has been generated by the navigation component. In this way, a vehicle equipped with the navigation system of the invention can easily be incorporated into a fleet management system; the position information can be sent in turns to a central fleet management office at the initiative of the navigation system or on request by the fleet management office. Such a position report can also be inserted into an emergency call that is for instance sent automatically in the event of an accident or on the instruction of the user.

In many cases, the memory of the navigation component contains not only the purely geographic data that are used by the processor for generating the navigation information but alphanumeric data as well, also called “travel guide information”, which can be displayed for the user essentially unprocessed, as a response to a request. In such a case, it is advantageous if the navigation system further includes a filter for identifying terminal addresses, within this alphanumeric information, that can be contacted with the aid of the mobile phone and forwarding an identified terminal address to the mobile phone, which can thereupon make a connection with the terminal designated by that address. This filter can be actuated manually, for instance by giving the user the capability of selecting one address within displayed alphanumeric information as the address to be contacted; however, an automatic filter can also be provided, which identifies such a terminal address from its syntax.

In order to make it possible for the vehicle navigation system to take current traffic status information into account, a transmission route for the supplementary geographic data, received by radio by the mobile phone, to the navigation component can expediently be provided. Such a transmission route can for instance be constructed by providing that the mobile phone itself examines received data, in particular SMS messages, for the presence of a predetermining characteristic that can serve as a criterion that the message includes supplementary geographic data, which are intended for evaluation by the navigation component, and which forwards messages thus characterized on to the navigation component. Another way, which requires no special capabilities of the mobile phone, is for the navigation component to “eavesdrop” on all the messages arriving at the mobile phone over the transmission route and from them, on the basis of the characteristic or on the basis of the caller ID, to select the messages intended for the navigation component and process them, and ignore all the others.

Expediently, the memory includes a data carrier reader unit and an interchangeable data carrier for the geographic data. In such a case, program information is advantageously also stored on the interchangeable data carrier, information that the processor of the navigation component uses in evaluating supplementary geographic data received by radio. These program components can each be adapted specifically to a particular message format that a particular telematics service provider uses for traffic status information that it sends. Thus by simply replacing the data carrier, the navigation system can be converted to the use of information from a different service provider. Particularly in trips that cross boundaries between countries, this is advantageous: If the data carrier is changed at the boundary, this automatically adapts the navigation system to a possibly different message format of a telematics service provider in the neighboring country.

Another possibility afforded by the use of a reader unit with an interchangeable data carrier is that a user, instead of the data carrier with the geographic data, can insert an arbitrary other compatible data carrier into the reader unit and can have data stored on it forwarded by the navigation component to the mobile phone for broadcast.

### DRAWINGS

Further characteristics and advantages of the present invention will become apparent from the ensuing description of exemplary embodiments in conjunction with the accompanying drawing.

The sole drawing FIGURE shows a basic sketch of a vehicle navigation system of the invention.

The system substantially comprises two components: a mobile phone 1, in this case a GSM cell phone with a cell-phone connection 17, and a navigation component 2, which communicate with one another via an interface, such as a serial interface 13 of the RS232 type. optionally, the mobile phone 1 and the navigation component 2 can also be connected to a speaker 3 of a hands-free system, for outputting audio signals to them.

The navigation component 2 includes the following elements, among others:

a power pack 18;

a memory with a CD-ROM drive 4, into which a CD-ROM can be inserted as a data carrier for geographic data, from which the navigation component 2 generates navigation information for a user; a read-write semiconductor memory (RAM) 5, and a nonvolatile semiconductor memory 11, such as a flash EPROM;

an interface circuit 6 for communication with the mobile phone 1;

a GPS receiver 7, which from a satellite signal received via an antenna furnishes information about the location of the system; and

a processor (CPU) 8, which in response to a request from the mobile phone 1 via the serial interface 13 generates navigation information from the geographic data contained in the memory and from the position information furnished by the GPS receiver 7.

To enhance the precision of position determination, the navigation component 2 is furthermore equipped with a gyro compass 9 and an input 10 for a vehicle speed signal, which are also taken into account by the processor 8 in ascertaining the location. The mobile phone 1 meets the GSM specification “Digital Cellular Telecommunications System (Phase 2+); AT Command Set for GSM Mobile Equipment (GSM07.07)”, Version 5.5.0 of the European Telecommunications Standards Institute (ETSI). This specification defines an abstract architecture for the communication of a mobile phone with a data terminal connected to it; the components comprising this architecture are mobile equipment (ME), terminal adaptor (TA), and terminal equipment (TE). Within the scope of the navigation system, it is provided that the function of the terminal adaptor and of the mobile equipment are integrated in a GSM Phase 2+ cell phone, which conversely the terminal equipment function is performed by the navigation component 2. The terminal equipment and the terminal adaptor communicate with the aid of so-called AT cellular commands, which give the navigation component 2 extensive control over the functions of the mobile phone 1. For instance, the aforementioned ETSI specification defines commands for outputting characters to the display field of the mobile phone, for calling up inputs on its keypad, and for simulating key actuations on the mobile phone. Commands for inputting a PIN code, for calling up the intensity of the received signal, and for controlling an energy-saving mode of the mobile phone are also defined.

By means of a event reporting mechanism, the navigation component 2 is informed of each pressing of the key, each change in a display, and each change in a symbol display on the mobile phone 1. Thus all the functions that are needed to enable using such a mobile phone as a user interface for a vehicle navigation system are present. Inputting a text, in particular a destination, is done by the well-known principle for mobile phones in which the number keys of a keypad 16 of the mobile phone are each assigned a plurality of alphanumeric characters, which can be selected by pressing the key repeatedly.

For outputting navigation information in text form, the command +CDIS mentioned in the aforementioned standard can be used. It is possible to adapt the format of the text display to various sizes of display field 15, depending on the model of mobile phone 1, in that the processor 8, using the commands +CMEC=? and +CDIS=?, calls up the number of rows and columns that are available on the display field.

It is also possible to display graphical symbols, by putting together a plurality of alphanumeric characters.

In a more-sophisticated embodiment, the navigation component 2 is also equipped with a speech output circuit 14, which makes it possible for an announcement stored in digitized form on the CD-ROM in the CD-ROM drive 4, or an announcement generated from a chain of characters, to the output to the speaker 3 of the hands-free system. In this way, a driver can effectively be supplied with navigation information even when he has no opportunity, in a complicated traffic situation, of actually looking at the display field of the mobile phone.

In another embodiment, not shown, it is also conceivable to equip the navigation component 2 with a speech recognition circuit, so that commands spoken by the driver to the navigation component 2 using a microphone of the hands-free system can be recognized and converted.

GSM standard 07.05 V5.5.0 also supports the sending and receiving of SMS messages using a connected terminal via a cell phone conforming to the standard. It is therefore possible with the mobile phone 1 to receive SMS messages from telematics service providers that contain information about traffic obstructions and to send this information on to the navigation component 2, where it is evaluated by the processor 8 and stored in the RAM 5, so that it is available as a supplement to the geographic information stored on the CD-ROM and can also be taken into account in the generation of navigation information.

The format of these SMS messages can vary, depending on the telematics service provider where they originate. To assure that these SMS messages can be evaluated correctly by the navigation component 2, it is possible also to accommodate a library with programmed functions required for this purpose on the CD-ROM in the drive 4; this library also includes the geographic data, and depending on the user I.D. received in an SMS message, the function suitable for evaluation can be selected from this library.

The capability of sending short messages via the mobile phone 1 can also be used for implementing fleet management systems economically, with the aid of the navigation system of the invention. The sole prerequisite for this is that the navigation component 2 be equipped with a program for the processor 8 that enables the processor, cyclically or on request from outside, to transmit an SMS message that contains information about the current location of the system. The navigation system 2 can then furnish even more-precise information about the location than conventional fleet management systems based only on GPS, because the navigation component of the invention is capable of taking into account not only the GPS signal but also the stored geographic data, the directional information furnished by the rotation rate sensor 9 and the speed information received via the signal input 10, and for instance from among all the possible locations compatible with a GPS signal received, it can exclude from consideration as current locations all locations where according to the geographic data there is no street or road. It is understood that the processor 8 can also evaluate positions obtained at an earlier time, so that from among a plurality of streets or roads compatible with a GPS signal, it can ascertain the particular one where the vehicle is located.

For proper functioning, the mobile phone 1 requires a SIM card (not shown), on which specific data about the user of the mobile phone are stored. The SIM card also includes a read-write memory that can be used to store telephone numbers and SMS messages. However, the size of this memory is limited. For instance in D1, only 14 SMS messages can at present be stored on the SIM card. The nonvolatile memory 11 of the navigation component 2 is considerably larger than the memory in the SIM card and is capable of permanently storing not only destination memory information, vehicle parameters, and so forth, but also a very large number of telephone numbers and SMS messages. In commercial use of a vehicle equipped with the navigation system, this has the advantage that the telephone number memory, which can for instance include customer addresses, is fixedly connected to the vehicle and always remains unchanged, even if different drivers, each with their own personal SIM card, use the vehicle.

This nonvolatile memory 11 can also be store e-mail addresses. By placing an e-mail address at the beginning of an SMS message and sending this SMS message to a specific service center, this SMS message is forwarded as an e-mail by the mobile network service providers D1 and D2. Conventional cell phones have no address memory for e-mail addresses. In the nonvolatile memory of the navigation component, however, even such e-mail addresses can be included. Instead of retyping an e-mail address every time, a user can therefore select such an address in the list in the navigation component and make it a header to the SMS message fully automatically.

The possibility of automatically generating SMS messages using the navigation system of the invention, messages that include information about the current location of the system, has already been mentioned above in conjunction with fleet management. It is understood that on command of the user, such an indication, optionally in conjunction with the associated time of day, can also be integrated automatically with an arbitrary other SMS message.

Often, the CD-ROM contains not only the geographic data which the navigation component 2 requires to make a route suggestion, but also a “travel guide database”, which for a given town or city can contain information on sightseeing, hotels, restaurants, movie theaters, car repair facilities, and more, along with addresses and telephone numbers. It is understood that the contents of such a travel guide database can also be displayed on the display field of the mobile phone 1 via the navigation component 2. If the user marks a displayed telephone number, for instance by moving a cursor over the display field, then it can be provided that in such a case the navigation component 2 automatically triggers the mobile phone 1 in order to make a telephone connection with the number dialed. Another possibility, which can easily be achieved by suitable programming of the processor 8 and is even more convenient in view of the limited size of the display field of the mobile phone 1, is that the processor automatically filters out telephone numbers in the travel guide database, for instance on the basis of the abbreviation “Tel.” preceding them, or their format, so that instead of displaying these telephone numbers, it displays other information stored in the travel database that pertains to the owner of the telephone number, for example in the case of a hotel the number of beds, its amenities, its address, and so forth, and automatically makes the connection when the user simply selects the name of the owner of the telephone number.

Another refinement allows the system of the invention also to be used for access to other data carriers that are readable in the CD-ROM drive 4. For instance, the drive 4 can also be used for playing audio CDs over the speaker 3 of the hands-free system or in conjunction with a car radio optionally connected to it via a connection 12.

Access to arbitrary databases on CD-ROM, such as dictionaries, address files, telephone information, first aid instructions, and so forth, is easily achieved here. For controlling the access to such applications, the processor 8 can be equipped with a simple operating system, similar to the conventional palmtop computer. Also in such applications the possibility exists, as described above, of automatically making connections with telephone numbers stored in memory.

In still another refinement of the system, it is provided that the user is offered the possibility of selecting data sets, from a data carrier in the drive 4, that are shown on the display field of the mobile phone 1 and forwarding these data sets to a partner via the mobile phone 1. This allows a company employee, working in the field for instance and carrying along a CD-ROM containing technical information, brochure material, or price lists from his company, to send such information material immediately upon request.

It should be noted that all these functions can be performed with a mobile phone that requires no specific adaptation whatever to the present invention, as long as it merely supports the commands, defined in GSM standard 07.07 V5.5.0, for communication with a connected terminal, or equivalent commands.

1. A vehicle navigation system, having a navigation component (2), which includes a memory (4, 5, 11) for geographic data and a processor (8) for generating navigation information from the geographic data, and having a user interface (1) for inputting requests to the navigation component (2) and for displaying navigation information furnished by the navigation component (2), characterized in that the user interface is a mobile phone (1).

2. The vehicle navigation system of claim 1, characterized in that the mobile phone (1) is coupled to the navigation component (2) via a serial interface (3).

3. The vehicle navigation system of claim 1 or 2, characterized in that the mobile phone (1) is set up for outputting alphanumeric or graphic information, furnished by the navigation component (2), to a display field (15).

4. The vehicle navigation system of one of the foregoing claims, characterized in that the mobile phone (1) is connected to a hands-free system for outputting audio information furnished by the navigation component (2) and/or for inputting a request to the navigation component.

5. The vehicle navigation system of one of the foregoing claims, characterized in that the navigation component (2) further includes a memory (11) for terminal addresses that can be contacted with the aid of the mobile phone, and that the mobile phone (1) is set up for accessing this memory (11) in order to contact a distant terminal.

6. The vehicle navigation system of one of the foregoing claims, characterized in that it is set up to send, with the aid of the mobile phone (1), information pertaining to its current position that has been generated by the navigation component (2).

7. The vehicle navigation system of one of the foregoing claims, characterized in that the memory (4, 5, 11) of the navigation component (2) includes alphanumeric information, and that a filter (8) is provided for identifying terminal addresses that can be contacted with the aid of the mobile phone (1) in the alphanumeric information and for forwarding an identified terminal address to the mobile phone (1).

8. The vehicle navigation system of one of the foregoing claims, characterized by a transmission route for data, received by radio by the mobile phone (1), to the navigation component (2).

9. The vehicle navigation system of claim 8, characterized in that the navigation component (2) has a device (8) for identifying and evaluating data, received by radio by the mobile phone (1), of the kind that include supplementary geographic data.

10. The vehicle navigation system of claim 9 and claim 10, characterized in that program information that the navigation component (2) uses in evaluating the supplementary geographic data is also stored on the interchangeable data carrier.

11. The vehicle navigation system of claim 10 or 11, characterized in that the navigation component (2) is set up for forwarding a data set, stored on a data carrier placed in the reader unit (4), to the mobile phone (1) for broadcast.
